(19) United States
(12) Patent Application Publication
(10) Pub. No.: US 2026/0180718 A1
(43) Pub. Date: Jun. 25, 2026

(54) EARLY RADIO LINK CONTROL RETRANSMISSION

(71) Applicant: QUALCOMM Incorporated, San Diego, CA (US)

(72) Inventor: Linhai HE, San Diego, CA (US)

(21) Appl. No.: 18/990,980

(22) Filed: Dec. 20, 2024

(51) Int. Cl. H04L 1/08; H04L 1/1607; H04L 5/00

(52) U.S. Cl. CPC H04L 1/08; H04L 1/1678; H04L 1/1685; H04L 5/0053

(57) ABSTRACT

Methods, systems, and devices for wireless communications are described. A wireless communication device may implement a radio link control (RLC) early retransmission procedure based on triggering criteria. The triggering criteria may include a threshold quantity of hybrid automatic repeat request retransmissions or a threshold remaining delay budget for a packet. When the criteria are satisfied for a given packet, the transmitting wireless communication device may start a timer. If the timer expires, the transmitting wireless communication device may perform an RLC retransmission of the packet. If the timer has a non-zero duration, the transmitting wireless communication device may transmit a polling request. The timer may be stopped when the transmitting wireless communication device receives a status report in response to the polling request or when the timer expires. If the status report indicates a negative acknowledgment for the packet, the transmitting wireless communication device may retransmit the packet.

### FIELD OF TECHNOLOGY

The following relates to wireless communications, including an early radio link control transmission.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

Aspects of the disclosure include a user equipment (UE) receiving an indication of triggering criteria associated with a radio link control early retransmission procedure. The UE may perform one or more transmissions of a packet to a second wireless communication device. The UE may then start a timer associated with the radio link control early retransmission procedure based at least in part on satisfaction of the triggering criteria for the packet. The UE then evaluates whether to retransmit the packet to the second wireless communication device based at least in part on an expiration status of the timer or on reception of a status report from the second wireless communication device.

The systems, methods, and devices of this disclosure each have several innovative aspects, no single one of which is solely responsible for the desirable attributes disclosed herein.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports early radio link control (RLC) retransmission in accordance with one or more aspects of the present disclosure.

FIG. 2 shows an example of a wireless communications system that supports early RLC retransmission in accordance with one or more aspects of the present disclosure.

FIG. 3 shows an example of a process flow that supports early RLC retransmission in accordance with one or more aspects of the present disclosure.

FIGS. 4 and 5 show block diagrams of devices that support early RLC retransmission in accordance with one or more aspects of the present disclosure.

FIG. 6 shows a block diagram of a communications manager that supports early RLC retransmission in accordance with one or more aspects of the present disclosure.

FIG. 7 shows a diagram of a system including a device that supports early RLC retransmission in accordance with one or more aspects of the present disclosure.

FIGS. 8 through 10 show flowcharts illustrating methods that support early RLC retransmission in accordance with one or more aspects of the present disclosure.

### DETAILED DESCRIPTION

A wireless communication device, such as a user equipment (UE) or a network entity, may be equipped with a protocol stack to support various functionalities associated with wireless communication. The protocol stack may include various protocol layers, including a radio link control (RLC) layer and a medium access control (MAC) layer. The RLC layer may perform the transfer of upper layer packets (e.g., protocol data units (PDUs)). In the case that the MAC layer fails to successfully transmit a packet to a receiving wireless communication device via a hybrid automatic repeat request (HARQ) process (e.g., the MAC layer does not receive a HARQ acknowledgment (ACK) for the PDU from the receiving wireless communication device), the RLC layer may implement an RLC retransmission procedure for the packet.

RLC retransmission may involve transmission by the transmitting wireless communication device of a polling request to the receiving wireless communication device and reception by the transmitting wireless communication device of a status report from the receiving wireless communication device in response to the polling request. The status report may indicate packets (e.g., service data units (SDUs)) successfully received by the receiving wireless communication device from the transmitting wireless communication device. SDUs may be consecutively numbered by sequence number in the order the transmitting wireless communication transmitted the SDUs. The status report may indicate the sequence numbers of the packets (e.g., SDUs) successfully received by the receiving wireless communication device (e.g., over a given duration of time). Accordingly, absence of a sequence number for a particular packet in the status report may be an implicit negative ACK (NACK). In response to an implicit NACK, the transmitting wireless communication device may retransmit the NACKed packet to the receiving wireless communication device. The RLC retransmission procedure may be repeated until the packet is ACKed in a status report or until a threshold quantity of retransmissions is reached, in which case the RLC layer of the transmitting wireless communication device may declare an RLC failure. RLC retransmission may be associated with delay due to the multiple round trip times associated with both the HARQ processes for the packet and the RLC retransmission procedure. Some types of packets, such as packets associated with extended reality (XR) applications, may have low latency demands which may be impacted by the delay associated with the RLC retransmission procedure.

In some examples, a wireless communication device may implement an RLC early retransmission procedure based on configured triggering criteria. For example, the triggering criteria may involve a threshold quantity of HARQ retransmissions and/or a threshold remaining delay budget for a packet. When the criteria are satisfied for a given packet, the transmitting wireless communication device may start a timer associated with the RLC early retransmission procedure. In some examples, the triggering criteria may include multiple possible conditions, such as the threshold quantity of HARQ retransmissions and a threshold remaining delay budget for a packet, and satisfaction of any one of the conditions may be a satisfaction of the triggering criteria (e.g., may trigger starting the timer associated with the RLC early retransmission process). If the timer expires, the transmitting wireless communication device may perform an RLC retransmission of the packet. The transmitting wireless communication device may generate a polling request to the receiving wireless communication device based on satisfaction of the triggering criteria. The polling request may be sent by the transmitting wireless communication device any time at or after satisfaction of the triggering criteria. The polling request may be an indicator in a header of a PDU sent by the transmitting wireless communication device. The timer may be stopped when the transmitting wireless communication device receives a status report in response to the polling request or when the timer expires. If the status report indicates a NACK for the packet, the transmitting wireless communication device may retransmit the packet. Accordingly, the criteria for triggering the RLC early retransmission procedure may be configured to account for delay budgets based on packet type. Similarly, the timer duration may be configured to enable quicker retransmission to account for delay budgets based on packet type. For example, the timer duration may be zero to enable immediate retransmission based on satisfaction of the triggering criteria. Accordingly, early RLC transmission may be configured to enable quicker RLC retransmission for delay-sensitive packets.

Aspects of the disclosure are initially described in the context of wireless communications systems. Aspects of the disclosure are further illustrated by and described with reference to process flows, apparatus diagrams, system diagrams, and flowcharts that relate to early RLC retransmission.

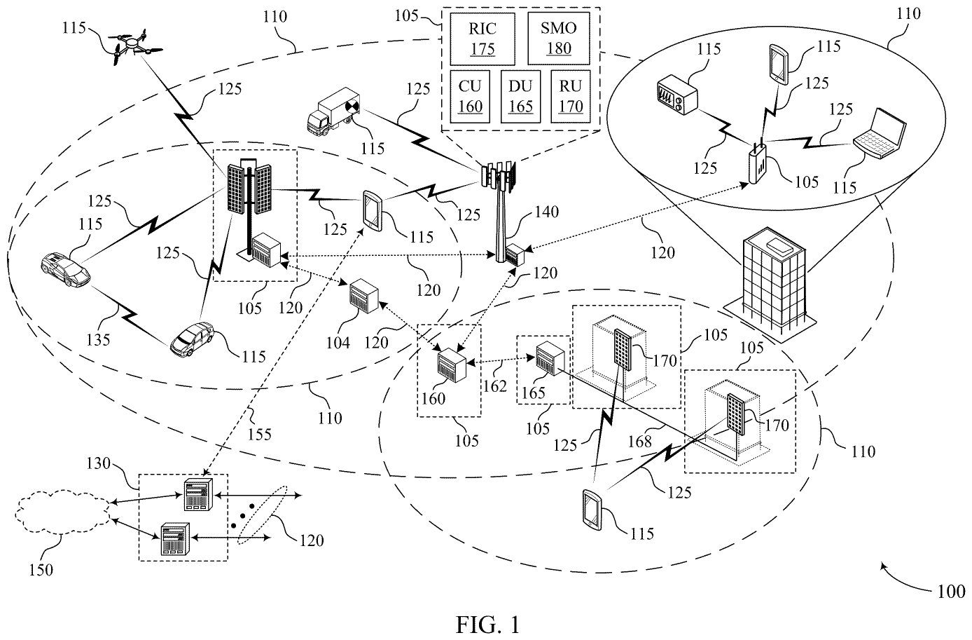

FIG. 1 shows an example of a wireless communications system 100 that supports early RLC retransmission in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L 3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L 1 ) (e.g., physical (PHY) layer) or L2 (e.g., RLC layer, MAC layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support early RLC retransmission as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. HARQ feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In the case that the MAC layer fails to successfully transmit a packet to a receiving wireless communication device via a HARQ process (e.g., the MAC layer does not receive a HARQ ACK for the PDU from the receiving wireless communication device), the RLC layer may implement an RLC retransmission procedure for the packet. RLC ARQ may involve transmission by the transmitting wireless communication device (e.g., a UE 115 in uplink or sidelink or a network entity 105 in downlink) of a PDU (e.g., the PDU that was not ACKed or was NACKed according to the HARQ process for the packet). After transmission of the PDU, the transmitting wireless communication device may wait for a status report from the receiving wireless communication device. If the status report does not indicate the successful reception of the PDU the transmitting wireless communication device may retransmit the PDU. The transmitting wireless communication device may transmit a polling request to the receiving wireless communication device (e.g., the network entity 105 in uplink or the UE 115 in downlink), which may trigger the receiving wireless communication device to transmit a status report in response to the polling request. The RLC ARQ process may be repeated until the packet is ACKed in a status report or until a threshold quantity of retransmissions is reached, in which case the RLC layer of the transmitting wireless communication device may abort the attempt to transmit the PDU and may declare an RLC failure. If an RLC failure is declared, if the transmitting wireless communication device is a UE 115, the UE 115 may perform RRC reconfiguration to connect with a different cell.

Network communication may be scheduled with a limited quantity of HARQ transmissions (e.g., a threshold quantity of HARQ retransmissions before attempting RLC ARQ). HARQ failure may occur with a low probability, and thus limiting the quantity of HARQ transmissions may increase resource efficiency. RLC ARQ transmission, however, may be associated with a longer delay than a HARQ process due to the multiple involved round trip times (e.g., for the initial HARQ process, the RLC retransmission, and the polling request and status reports). Some types of packets, such as packets associated with XR, may be delay sensitive, and the delay associated with the round trip times of RLC retransmission may impact the performance of such packets.

In some examples, autonomous retransmission may be implemented to reduce the RLC retransmission duration. For example, when configured conditions are met (e.g., the conditions may be a packet type or delay budget), a transmitting wireless communication device may retransmit an SDU before the status report for that SDU is received. In some examples, a new polling trigger may be introduced that may be dependent on the SDU delay status. The delay status may refer to how much time is left in a delay budget of an SDU, where the delay budget may be set based on the Quality of Service (QoS) for a particular logical channel.

In some examples, as described herein, early RLC retransmission may be implemented based on configured triggering criteria (e.g., to use or combine autonomous retransmission and polling enhancements). The network may tune the configuration parameters (e.g., triggering criteria and/or durations for autonomous RLC retransmission). For example, the triggering criteria may include conditions such as a threshold quantity of HARQ retransmissions or a threshold remaining delay budget for a packet. For example, the triggering criteria may be satisfied for a packet when one or more of the conditions of the triggering criteria (e.g., a threshold quantity of HARQ retransmissions or a threshold remaining delay budget for a packet) is met for the packet. When the triggering criteria are satisfied for a given packet, the transmitting wireless communication device may start a timer associated with the RLC early retransmission procedure. If the timer expires, the transmitting wireless communication device may perform an RLC retransmission of the packet. The transmitting wireless communication device may generate a polling request to the receiving wireless communication device based on satisfaction of the triggering criteria. The polling request may be sent by the transmitting wireless communication device any time at or after satisfaction of the triggering criteria. The timer may be stopped when the transmitting wireless communication device receives a status report in response to the polling request or when the timer expires. If the status report indicates a NACK for the packet, the transmitting wireless communication device may retransmit the packet. Accordingly, the criteria for triggering the RLC early retransmission procedure may be configured to account for delay budgets based on packet type. Similarly, the timer duration may be configured to enable quicker retransmission to account for delay budgets based on packet type. For example, the timer duration may be zero to enable immediate retransmission based on satisfaction of the triggering criteria. Accordingly, early RLC transmission may be configured to enable quicker RLC retransmission for delay-sensitive packets.

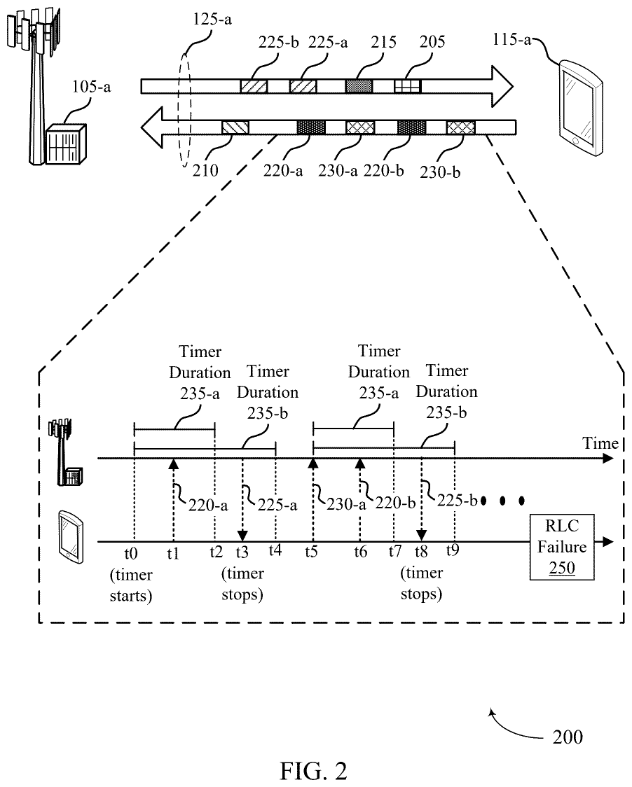

FIG. 2 shows an example of a wireless communications system 200 that supports early RLC retransmission in accordance with one or more aspects of the present disclosure. The wireless communications system 200 may implement or may be implemented by aspects of the wireless communications system 100. For example, the wireless communications system 200 includes a UE 115-a, which may be an example of a UE 115 as described herein. The wireless communications system 200 also includes a network entity 105-a, which may be an example of a network entity 105 as described herein.

The UE 115-a may communicate with the network entity 105-a using a communication link 125-a. The communication link 125-a may be an example of an NR or LTE link between the UE 115-a and the network entity 105-a. The communication link 125-a may include bi-directional links that enable both uplink and downlink communications. For example, the UE 115-a may transmit uplink signals, such as uplink control signals or uplink data signals, to the network entity 105-a using the communication link 125-a and the network entity 105-a may transmit downlink signals, such as downlink control signals or downlink data signals, to the UE 115-a using the communication link 125-a.

As described herein, the UE 115-a may implement early RLC retransmission. For example, the network entity 105-a may transmit control signaling 205 that may indicate triggering criteria associated with the early RLC retransmission procedure. In some examples, the triggering criteria may be a threshold quantity of retransmissions (e.g., a threshold quantity of HARQ processes for a packet) or a remaining delay budget threshold (e.g., a delay status threshold). In some examples, the triggering criteria may include multiple configured conditions (e.g., a threshold quantity of HARQ processes for a packet and a remaining delay budget threshold), where satisfaction of any one of the configured conditions for the packet (e.g., a quantity of HARQ processes that exceeds the threshold quantity of HARQ processes for the packet or a remaining delay budget for the packet below the remaining delay budget threshold) may correspond to satisfaction of the triggering criteria for the packet. In some examples, the triggering criteria may be configured per packet type (e.g., per communication type such as XR, ultra reliable low latency communications (URLLC), etc.) or per QoS to account for different delay sensitivities of different packet types.

The UE 115-a may perform one or more transmissions 210 of a packet. For example, the one or more transmissions 210 may be physical uplink shared channels (PUSCH) transmissions that convey the packet. The one or more transmissions of the packet may be transmitted in accordance with one or more HARQ processes scheduled for the packet (e.g., in scheduling information provided by the network entity 105-a to the UE 115-a for the packet). For example, some of the one or more transmissions 210 may be retransmissions of the packet backed on NACK(s) 215 received from the network entity 105-a.

At time t0, the UE 115-a may detect, determine, or identify satisfaction of the triggering criteria configured for the early RLC retransmission procedure for the packet. Accordingly, at time t0 the UE 115-a may start a timer associated with the early RLC retransmission procedure and wait for a status report 225-a from the network entity 105-a. The timer associated with the early RLC retransmission procedure may be referred to as timelyReTx timer. In some examples, the control signaling 205 may indicate a duration of the timer. In some examples, the duration of the timer may be pre-configured or standardized (e.g., based on the QoS or packet type). In some examples, the duration of the timer may be zero, in which case the timer may expire as soon as the timer is initiated at time t0, and the UE 115-a may be triggered to send a retransmission 230-a of the packet. In some examples, t5 at which the UE 115-a transmits the retransmission 230-a may be immediate with respect to t0 (e.g., in the case where the duration of the timer is zero).

In some examples, the duration 235 of the timer may be non-zero. The UE 115-may transmit a polling request 220-a (e.g., at time t1) to request the status report 225-a. In some examples, if the timer duration is zero, the UE 115-a may not wait for the status report 225-a responsive to the polling request 220-a to transmit the retransmission 230-a. In some examples, t1 may be the same as t0 (e.g., the UE 115-a may simultaneously transmit the polling request 220-a and start the timer). For example, the polling request 220-a may be generated when the UE 115-a detects satisfaction of the triggering criteria. The UE 115-a may stop the timer when the timer expires, in which case the UE 115-a may send the retransmission 230-a of the packet, or when the UE 115-a receives the status report 225-a. If the timer expires before the UE 115-a receives the status report 225-a (e.g., as shown in FIG. 2 where the duration of the timer is the duration 235-a) the UE 115-a may send the retransmission 230-a without waiting for the status report 225-a (e.g., t5 may be any time at or after t2 when the timer expired). If the UE 115-a receives the status report 225-a before the expiration of the timer (e.g., as shown in FIG. 2 where the timer duration is the duration 235-b), the UE 115-a may stop the timer regardless of whether the status report 225-a contains an implicit ACK or NACK for the packet. If the status report 225-a contains an implicit ACK, the UE 115-a may stop the early RLC retransmission procedure. If the status report 225-a contains an implicit NACK for the packet, the UE 115-a may send the retransmission 230-a at time t5 (e.g., t5 may be any time at or after t3 when the status report 225-a was received).

Based on sending the retransmission 230-a, the UE 115-a may reset and restart the timer. The UE 115-a may repeat the process (e.g., sending a polling request 220-b for a subsequent status report 225-b and sending a subsequent retransmission 230-b if the timer expires or the subsequent status report 225-b indicates an implicit NACK) until a status report 225 indicates an ACK for the packet or a threshold quantity of retransmission attempts is reached, in which case the UE 115-a may declare an RLC failure 250. The RLC failure may trigger an RRC reconnection procedure between the UE 115-a and the network entity 105-a (e.g., to select a new cell for communication between the UE 115-a and the network entity 105-a).

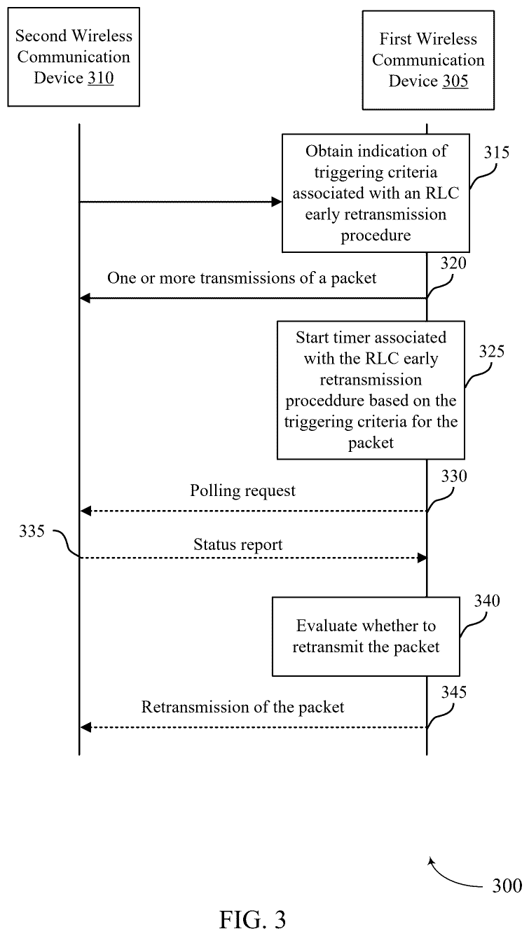

FIG. 3 shows an example of a process flow 300 that supports early RLC retransmission in accordance with one or more aspects of the present disclosure. The process flow 300 may implement or may be implemented by aspects of the wireless communications system 100 or the wireless communications system 200. For example, the process flow 300 includes a first wireless communication device 305, which may be an example of a UE 115 or a network entity 105 as described herein. The process flow 300 also includes a second wireless communication device 310, which may be an example of a UE 115 or a network entity 105 as described herein.

At 315, the first wireless communication device 305 may obtain an indication of triggering criteria associated with an RLC early retransmission procedure. For example, the first wireless communication device 305 may obtain the triggering criteria from memory of the first wireless communication device 305 (e.g., where the triggering criteria are predefined or standardized). As another example, the first wireless communication device 305 may receive control signaling from the second wireless communication device 310 that indicates the triggering criteria.

At 320, the first wireless communication device 305 may perform one or more transmissions of a packet to the second wireless communication device 310. For example, in an uplink scenario, the one or more transmissions may be uplink transmissions, the first wireless communication device may be a UE 115, and the second wireless communication device 310 may be a network entity 105. As another example, in a downlink scenario, the one or more transmissions may be downlink transmissions, the first wireless communication device 305 may be a network entity 105, and the second wireless communication device 310 may be a UE 115. As another example, in a sidelink scenario, the one or more transmissions may be sidelink transmissions, the first wireless communication device may be a first UE 115, and the second wireless communication device 310 may be a second UE 115.

At 325, the first wireless communication device 305 may start a timer associated with the RLC early retransmission procedure based on satisfaction of the triggering criteria for the packet.

In some examples, at 330, the first wireless communication device 305 may generate a polling request to the second wireless communication device for a status report based on satisfaction of the triggering criteria. The polling request may be sent by the first wireless communication device 305 any time at or after satisfaction of the triggering criteria at 325. In some such examples, at 335, the first wireless communication device 305 may receive, from the second wireless communication device 310, the status report prior to the expiration status of the timer based on the polling request. The first wireless communication device 305 may stop (e.g., and reset) the timer based on reception of the status report at 335.

At 340, the first wireless communication device 305 may evaluate whether to retransmit the packet to the second wireless communication device based on an expiration status of the timer or based on reception of the status report from the second wireless communication device 310.

In some examples, at 345, the first wireless communication device 305 may perform a retransmission of the packet based on the status report (e.g., at 335) indicating a NACK for the packet. In some examples, the first wireless communication device 305 may refrain from performing the retransmission of the packet based on the status report at 335 indicating an ACK for the packet.

In some examples, at 345, the first wireless communication device 305 may perform a retransmission of the packet based on the expiration status of the timer (e.g., based on the timer expiring). In some examples, the duration of the timer may be zero, in which case the first wireless communication device 305 may be triggered to retransmit the packet at 345 as soon as the first wireless communication device 305 detects the satisfaction of the triggering criteria.

In some examples, the first wireless communication device 305 may receive or obtain an indication of the timer duration (e.g., in the same or different control signaling as the indication of the triggering criteria or from memory of the first wireless communication device 305).

In some examples, the triggering criteria may include a threshold quantity of HARQ retransmissions of the packet, a threshold remaining delay budget for the packet, or a combination thereof. For example, the triggering criteria may include multiple possible conditions, such as the threshold quantity of HARQ retransmissions and a threshold remaining delay budget for a packet, and satisfaction of any one of the conditions may be a satisfaction of the triggering criteria (e.g., may trigger starting the timer associated with the RLC early retransmission process). In some examples, the one or more transmissions at 320 may include a first transmission and one or more HARQ retransmissions of the packet, and satisfaction of the triggering criteria at 325 may include the one or more HARQ retransmissions of the packet exceeding the threshold quantity of HARQ transmissions. In some examples, satisfaction of the triggering criteria at 325 may include a remaining delay budget for the packet being below the threshold remaining delay budget for the packet.

In some examples, in the case where a status report for the retransmission at 345 indicates a NACK for the packet, the first wireless communication device 305 may repeat the early retransmission process (e.g., 325-345) until the first wireless communication device 305 receives a status report that indicates an ACK for the packet or a threshold quantity of retransmission attempts is reached, in which case the first wireless communication device 305 may declare an RLC failure.

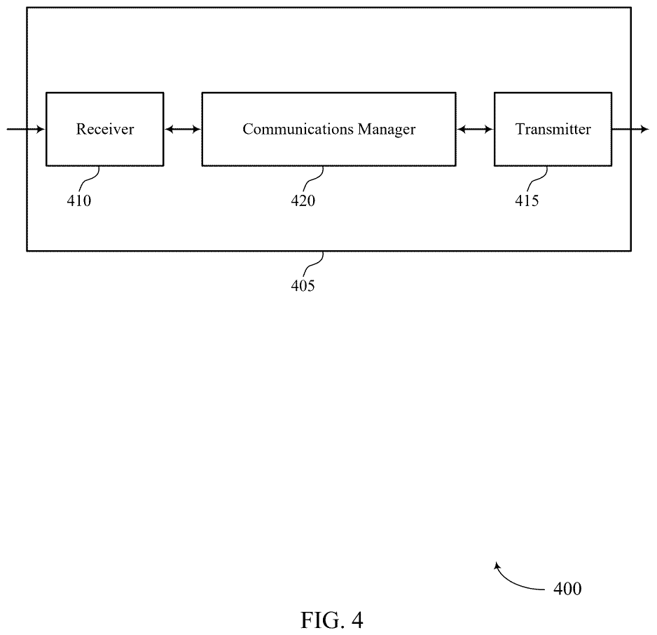

FIG. 4 shows a block diagram 400 of a device 405 that supports early RLC retransmission in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to early RLC retransmission). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to early RLC retransmission). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of early RLC retransmission as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving an indication of triggering criteria associated with an RLC early retransmission procedure. The communications manager 420 is capable of, configured to, or operable to support a means for performing one or more transmissions of a packet to a second wireless communication device. The communications manager 420 is capable of, configured to, or operable to support a means for starting a timer associated with the RLC early retransmission procedure based on satisfaction of the triggering criteria for the packet. The communications manager 420 is capable of, configured to, or operable to support a means for evaluating whether to retransmit the packet to the second wireless communication device based on an expiration status of the timer or on reception of a status report from the second wireless communication device.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for more efficient utilization of communication resources.

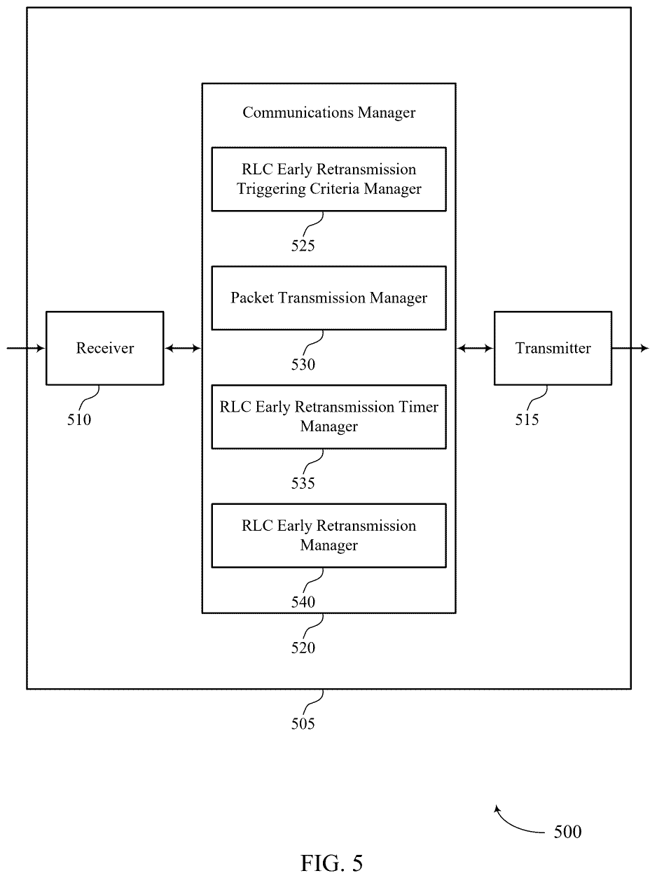

FIG. 5 shows a block diagram 500 of a device 505 that supports early RLC retransmission in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to early RLC retransmission). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to early RLC retransmission). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of early RLC retransmission as described herein. For example, the communications manager 520 may include an RLC early retransmission triggering criteria manager 525, a packet transmission manager 530, an RLC early retransmission timer manager 535, an RLC early retransmission manager 540, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The RLC early retransmission triggering criteria manager 525 is capable of, configured to, or operable to support a means for receiving an indication of triggering criteria associated with an RLC early retransmission procedure. The packet transmission manager 530 is capable of, configured to, or operable to support a means for performing one or more transmissions of a packet to a second wireless communication device. The RLC early retransmission timer manager 535 is capable of, configured to, or operable to support a means for starting a timer associated with the RLC early retransmission procedure based on satisfaction of the triggering criteria for the packet. The RLC early retransmission manager 540 is capable of, configured to, or operable to support a means for evaluating whether to retransmit the packet to the second wireless communication device based on an expiration status of the timer or on reception of a status report from the second wireless communication device.

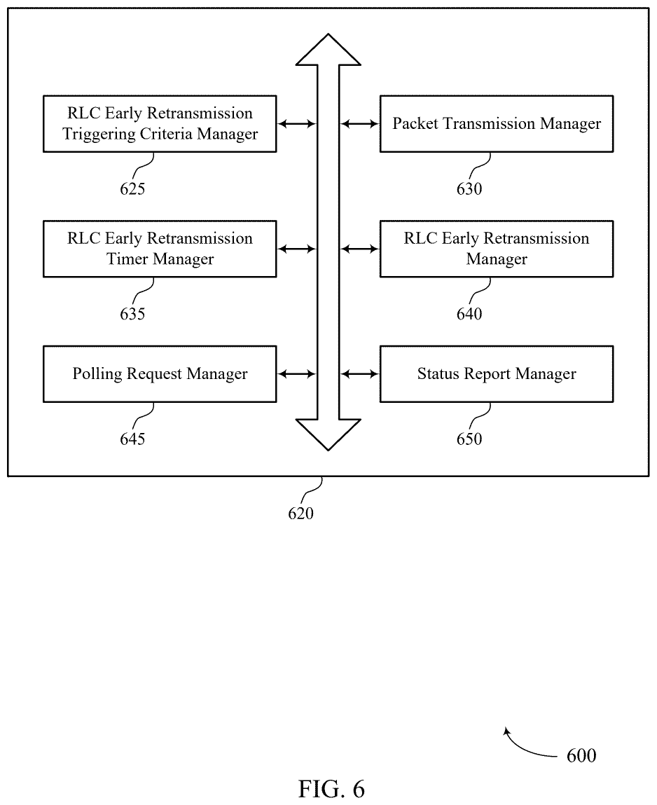

FIG. 6 shows a block diagram 600 of a communications manager 620 that supports early RLC retransmission in accordance with one or more aspects of the present disclosure. The communications manager 620 may be an example of aspects of a communications manager 420, a communications manager 520, or both, as described herein. The communications manager 620, or various components thereof, may be an example of means for performing various aspects of early RLC retransmission as described herein. For example, the communications manager 620 may include an RLC early retransmission triggering criteria manager 625, a packet transmission manager 630, an RLC early retransmission timer manager 635, an RLC early retransmission manager 640, a polling request manager 645, a status report manager 650, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The RLC early retransmission triggering criteria manager 625 is capable of, configured to, or operable to support a means for receiving an indication of triggering criteria associated with an RLC early retransmission procedure. The packet transmission manager 630 is capable of, configured to, or operable to support a means for performing one or more transmissions of a packet to a second wireless communication device. The RLC early retransmission timer manager 635 is capable of, configured to, or operable to support a means for starting a timer associated with the RLC early retransmission procedure based on satisfaction of the triggering criteria for the packet. The RLC early retransmission manager 640 is capable of, configured to, or operable to support a means for evaluating whether to retransmit the packet to the second wireless communication device based on an expiration status of the timer or on reception of a status report from the second wireless communication device.

In some examples, the polling request manager 645 is capable of, configured to, or operable to support a means for transmitting a polling request to the second wireless communication device for the status report based on the satisfaction of the triggering criteria for the packet.

In some examples, the status report manager 650 is capable of, configured to, or operable to support a means for receiving the status report prior to the expiration status of the timer based on the polling request.

In some examples, the RLC early retransmission manager 640 is capable of, configured to, or operable to support a means for performing a retransmission of the packet based on the status report indicating a NACK for the packet.

In some examples, the RLC early retransmission manager 640 is capable of, configured to, or operable to support a means for refraining from performance of a retransmission of the packet based on the status report indicating an ACK for the packet.

In some examples, the RLC early retransmission manager 640 is capable of, configured to, or operable to support a means for performing a retransmission of the packet based on the expiration status of the timer.

In some examples, a duration of the timer is zero.

In some examples, the RLC early retransmission timer manager 635 is capable of, configured to, or operable to support a means for receiving an indication of a duration of the timer.

In some examples, the triggering criteria includes a threshold quantity of HARQ retransmissions of the packet, a threshold remaining delay budget for the packet, or a combination thereof.

In some examples, to support performing the one or more transmissions, the packet transmission manager 630 is capable of, configured to, or operable to support a means for performing a first transmission and one or more HARQ retransmissions of the packet, where satisfaction of the triggering criteria includes the one or more HARQ retransmissions of the packet exceeding the threshold quantity of HARQ retransmissions.

In some examples, satisfaction of the triggering criteria includes a remaining delay budget for the packet being below the threshold remaining delay budget for the packet.

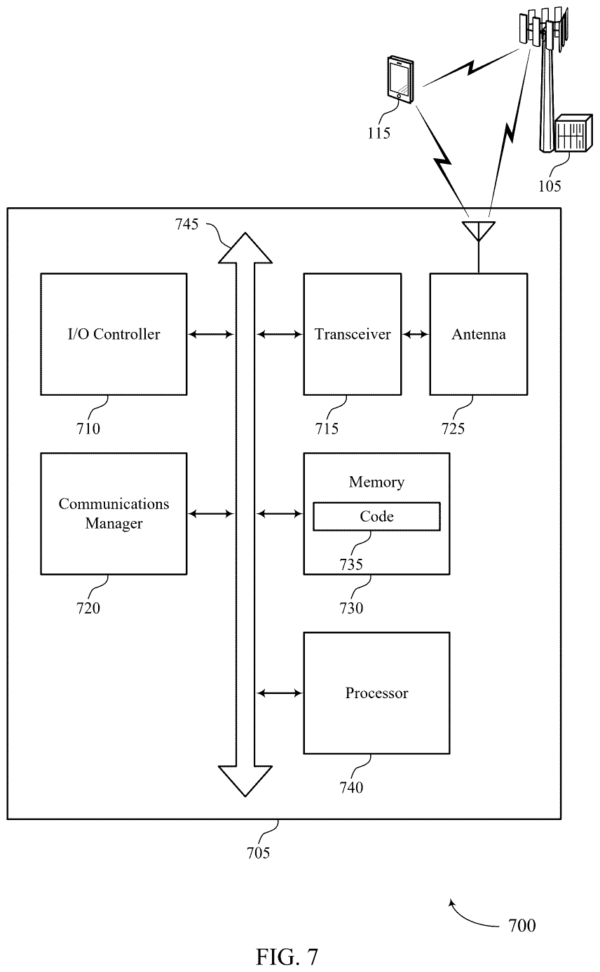

FIG. 7 shows a diagram of a system 700 including a device 705 that supports early RLC retransmission in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting early RLC retransmission). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving an indication of triggering criteria associated with an RLC early retransmission procedure. The communications manager 720 is capable of, configured to, or operable to support a means for performing one or more transmissions of a packet to a second wireless communication device. The communications manager 720 is capable of, configured to, or operable to support a means for starting a timer associated with the RLC early retransmission procedure based on satisfaction of the triggering criteria for the packet. The communications manager 720 is capable of, configured to, or operable to support a means for evaluating whether to retransmit the packet to the second wireless communication device based on an expiration status of the timer or on reception of a status report from the second wireless communication device.

By including or configuring the communications manager 720 in accordance with examples as described herein, the device 705 may support techniques for improved communication reliability, more efficient utilization of communication resources, and improved coordination between devices.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of early RLC retransmission as described herein, or the at least one processor 740 and the at least one memory 730 may be otherwise configured to, individually or collectively, perform or support such operations.

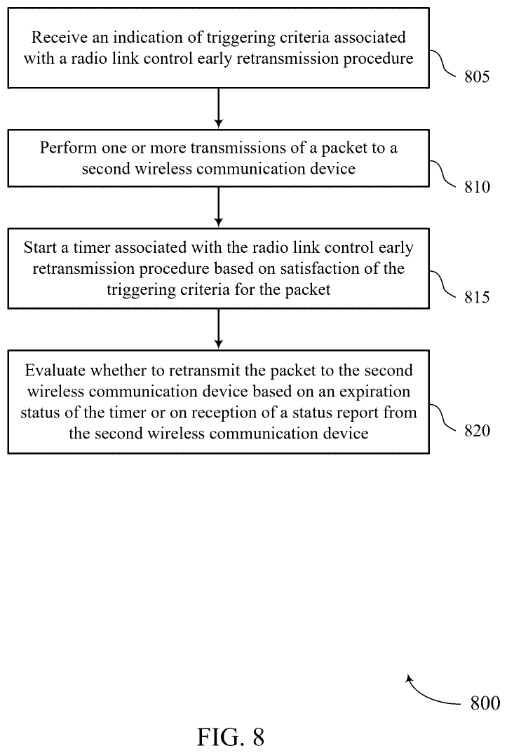

FIG. 8 shows a flowchart illustrating a method 800 that supports early RLC retransmission in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include receiving an indication of triggering criteria associated with an RLC early retransmission procedure. The operations of 805 may be performed in accordance with examples as disclosed herein. In some examples, aspects of the operations of 805 may be performed by an RLC early retransmission triggering criteria manager 625 as described with reference to FIG. 6.

At 810, the method may include performing one or more transmissions of a packet to a second wireless communication device. The operations of 810 may be performed in accordance with examples as disclosed herein. In some examples, aspects of the operations of 810 may be performed by a packet transmission manager 630 as described with reference to FIG. 6.

At 815, the method may include starting a timer associated with the RLC early retransmission procedure based on satisfaction of the triggering criteria for the packet. The operations of 815 may be performed in accordance with examples as disclosed herein. In some examples, aspects of the operations of 815 may be performed by an RLC early retransmission timer manager 635 as described with reference to FIG. 6.

At 820, the method may include evaluating whether to retransmit the packet to the second wireless communication device based on an expiration status of the timer or on reception of a status report from the second wireless communication device. The operations of 820 may be performed in accordance with examples as disclosed herein. In some examples, aspects of the operations of 820 may be performed by an RLC early retransmission manager 640 as described with reference to FIG. 6.

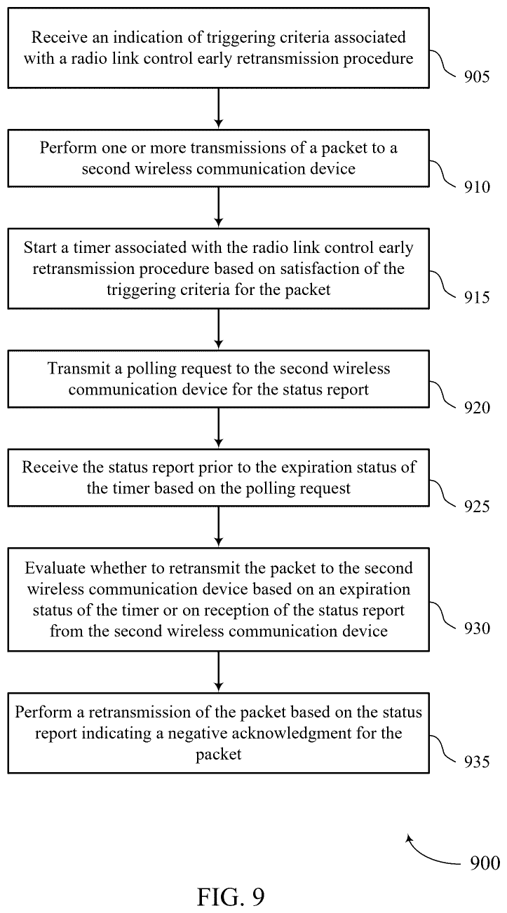

FIG. 9 shows a flowchart illustrating a method 900 that supports early RLC retransmission in accordance with one or more aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 905, the method may include receiving an indication of triggering criteria associated with an RLC early retransmission procedure. The operations of 905 may be performed in accordance with examples as disclosed herein. In some examples, aspects of the operations of 905 may be performed by an RLC early retransmission triggering criteria manager 625 as described with reference to FIG. 6.

At 910, the method may include performing one or more transmissions of a packet to a second wireless communication device. The operations of 910 may be performed in accordance with examples as disclosed herein. In some examples, aspects of the operations of 910 may be performed by a packet transmission manager 630 as described with reference to FIG. 6.

At 915, the method may include starting a timer associated with the RLC early retransmission procedure based on satisfaction of the triggering criteria for the packet. The operations of 915 may be performed in accordance with examples as disclosed herein. In some examples, aspects of the operations of 915 may be performed by an RLC early retransmission timer manager 635 as described with reference to FIG. 6.

At 920, the method may include transmitting a polling request to the second wireless communication device for the status report. The operations of 920 may be performed in accordance with examples as disclosed herein. In some examples, aspects of the operations of 920 may be performed by a polling request manager 645 as described with reference to FIG. 6.

At 925, the method may include receiving the status report prior to the expiration status of the timer based on the polling request. The operations of 925 may be performed in accordance with examples as disclosed herein. In some examples, aspects of the operations of 925 may be performed by a status report manager 650 as described with reference to FIG. 6.

At 930, the method may include evaluating whether to retransmit the packet to the second wireless communication device based on an expiration status of the timer or on reception of the status report from the second wireless communication device. The operations of 930 may be performed in accordance with examples as disclosed herein. In some examples, aspects of the operations of 930 may be performed by an RLC early retransmission manager 640 as described with reference to FIG. 6.

At 935, the method may include performing a retransmission of the packet based on the status report indicating a NACK for the packet. The operations of 935 may be performed in accordance with examples as disclosed herein. In some examples, aspects of the operations of 935 may be performed by an RLC early retransmission manager 640 as described with reference to FIG. 6.

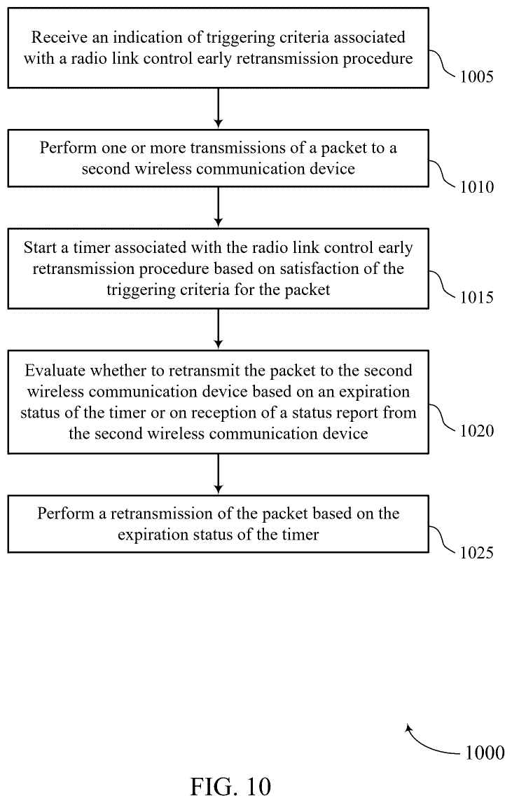

FIG. 10 shows a flowchart illustrating a method 1000 that supports early RLC retransmission in accordance with one or more aspects of the present disclosure. The operations of the method 1000 may be implemented by a UE or its components as described herein. For example, the operations of the method 1000 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1005, the method may include receiving an indication of triggering criteria associated with an RLC early retransmission procedure. The operations of 1005 may be performed in accordance with examples as disclosed herein. In some examples, aspects of the operations of 1005 may be performed by an RLC early retransmission triggering criteria manager 625 as described with reference to FIG. 6.

At 1010, the method may include performing one or more transmissions of a packet to a second wireless communication device. The operations of 1010 may be performed in accordance with examples as disclosed herein. In some examples, aspects of the operations of 1010 may be performed by a packet transmission manager 630 as described with reference to FIG. 6.

At 1015, the method may include starting a timer associated with the RLC early retransmission procedure based on satisfaction of the triggering criteria for the packet. The operations of 1015 may be performed in accordance with examples as disclosed herein. In some examples, aspects of the operations of 1015 may be performed by an RLC early retransmission timer manager 635 as described with reference to FIG. 6.

At 1020, the method may include evaluating whether to retransmit the packet to the second wireless communication device based on an expiration status of the timer or on reception of a status report from the second wireless communication device. The operations of 1020 may be performed in accordance with examples as disclosed herein. In some examples, aspects of the operations of 1020 may be performed by an RLC early retransmission manager 640 as described with reference to FIG. 6.

At 1025, the method may include performing a retransmission of the packet based on the expiration status of the timer. The operations of 1025 may be performed in accordance with examples as disclosed herein. In some examples, aspects of the operations of 1025 may be performed by an RLC early retransmission manager 640 as described with reference to FIG. 6.

The following provides an overview of aspects of the present disclosure:

Aspect 1: A method for wireless communications at a first wireless communication device, comprising: receiving an indication of triggering criteria associated with an RLC early retransmission procedure; performing one or more transmissions of a packet to a second wireless communication device; starting a timer associated with the RLC early retransmission procedure based at least in part on satisfaction of the triggering criteria for the packet; and evaluating whether to retransmit the packet to the second wireless communication device based at least in part on an expiration status of the timer or on reception of a status report from the second wireless communication device.

Aspect 2: The method of aspect 1, further comprising: transmitting a polling request to the second wireless communication device for the status report based at least in part on the satisfaction of the triggering criteria for the packet.

Aspect 3: The method of aspect 2, further comprising: receiving the status report prior to the expiration status of the timer based at least in part on the polling request.

Aspect 4: The method of aspect 3, further comprising: performing a retransmission of the packet based at least in part on the status report indicating a negative acknowledgment for the packet.

Aspect 5: The method of aspect 3, further comprising: refraining from performance of a retransmission of the packet based at least in part on the status report indicating an acknowledgment for the packet.

Aspect 6: The method of any of aspects 1 through 2, further comprising: performing a retransmission of the packet based at least in part on the expiration status of the timer.

Aspect 7: The method of aspect 6, wherein a duration of the timer is zero.

Aspect 8: The method of any of aspects 1 through 7, further comprising: receiving an indication of a duration of the timer.

Aspect 9: The method of any of aspects 1 through 8, wherein the triggering criteria comprises a threshold quantity of HARQ retransmissions of the packet, a threshold remaining delay budget for the packet, or a combination thereof.

Aspect 10: The method of aspect 9, wherein performing the one or more transmissions comprises: performing a first transmission and one or more HARQ retransmissions of the packet, wherein satisfaction of the triggering criteria comprises the one or more HARQ retransmissions of the packet exceeding the threshold quantity of HARQ retransmissions.

Aspect 11: The method of aspect 10, wherein satisfaction of the triggering criteria comprises a remaining delay budget for the packet being below the threshold remaining delay budget for the packet.

Aspect 12: A first wireless communication device for wireless communications, comprising one or more memories storing processor-executable code, and one or more processors coupled with the one or more memories and individually or collectively operable to execute the code to cause the first wireless communication device to perform a method of any of aspects 1 through 11.

Aspect 13: A first wireless communication device for wireless communications, comprising at least one means for performing a method of any of aspects 1 through 11.

Aspect 14: A non-transitory computer-readable medium storing code for wireless communications, the code comprising instructions executable by one or more processors to perform a method of any of aspects 1 through 11.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first wireless communication device, comprising:
one or more memories storing processor-executable code; and
one or more processors coupled with the one or more memories and individually or collectively operable to execute the code to cause the first wireless communication device to:
receive an indication of triggering criteria associated with a radio link control early retransmission procedure;
perform one or more transmissions of a packet to a second wireless communication device;
start a timer associated with the radio link control early retransmission procedure based at least in part on satisfaction of the triggering criteria for the packet; and
evaluate whether to retransmit the packet to the second wireless communication device based at least in part on an expiration status of the timer or on reception of a status report from the second wireless communication device.

2. The first wireless communication device of claim 1, wherein the one or more processors are individually or collectively further operable to execute the code to cause the first wireless communication device to:
transmit a polling request to the second wireless communication device for the status report based at least in part on the satisfaction of the triggering criteria for the packet.

3. The first wireless communication device of claim 2, wherein the one or more processors are individually or collectively further operable to execute the code to cause the first wireless communication device to:
receive the status report prior to the expiration status of the timer based at least in part on the polling request.

4. The first wireless communication device of claim 3, wherein the one or more processors are individually or collectively further operable to execute the code to cause the first wireless communication device to:
perform a retransmission of the packet based at least in part on the status report indicating a negative acknowledgment for the packet.

5. The first wireless communication device of claim 3, wherein the one or more processors are individually or collectively further operable to execute the code to cause the first wireless communication device to:
refrain from performance of a retransmission of the packet based at least in part on the status report indicating an acknowledgment for the packet.

6. The first wireless communication device of claim 1, wherein the one or more processors are individually or collectively further operable to execute the code to cause the first wireless communication device to:
perform a retransmission of the packet based at least in part on the expiration status of the timer.

7. The first wireless communication device of claim 6, wherein:
a duration of the timer is zero.

8. The first wireless communication device of claim 1, wherein the one or more processors are individually or collectively further operable to execute the code to cause the first wireless communication device to:
receive an indication of a duration of the timer.

9. The first wireless communication device of claim 1, wherein the triggering criteria comprises a threshold quantity of hybrid automatic repeat request retransmissions of the packet, a threshold remaining delay budget for the packet, or a combination thereof.

10. The first wireless communication device of claim 9, wherein, to perform the one or more transmissions, the one or more processors are individually or collectively operable to execute the code to cause the first wireless communication device to:
perform a first transmission and one or more hybrid automatic repeat request retransmissions of the packet, wherein satisfaction of the triggering criteria comprises the one or more hybrid automatic repeat request retransmissions of the packet exceeding the threshold quantity of hybrid automatic repeat request retransmissions.

11. The first wireless communication device of claim 10, wherein satisfaction of the triggering criteria comprises a remaining delay budget for the packet being below the threshold remaining delay budget for the packet.

12. A method for wireless communications at a first wireless communication device, comprising:
receiving an indication of triggering criteria associated with a radio link control early retransmission procedure;
performing one or more transmissions of a packet to a second wireless communication device;
starting a timer associated with the radio link control early retransmission procedure based at least in part on satisfaction of the triggering criteria for the packet; and
evaluating whether to retransmit the packet to the second wireless communication device based at least in part on an expiration status of the timer or on reception of a status report from the second wireless communication device.

13. The method of claim 12, wherein a duration of the timer is non-zero, the method further comprising:
transmitting a polling request to the second wireless communication device for the status report.

14. The method of claim 13, further comprising:
receiving the status report prior to the expiration status of the timer based at least in part on the polling request.

15. The method of claim 14, further comprising:
performing a retransmission of the packet based at least in part on the status report indicating a negative acknowledgment for the packet.

16. The method of claim 14, further comprising:
refraining from performance of a retransmission of the packet based at least in part on the status report indicating an acknowledgment for the packet.

17. The method of claim 12, further comprising:
performing a retransmission of the packet based at least in part on the expiration status of the timer.

18. The method of claim 17, wherein a duration of the timer is zero.

19. The method of claim 12, further comprising:
receiving an indication of a duration of the timer.

20. A non-transitory computer-readable medium storing code for wireless communications, the code comprising instructions executable by one or more processors to:
receive an indication of triggering criteria associated with a radio link control early retransmission procedure;
perform one or more transmissions of a packet to a second wireless communication device;
start a timer associated with the radio link control early retransmission procedure based at least in part on satisfaction of the triggering criteria for the packet; and
evaluate whether to retransmit the packet to the second wireless communication device based at least in part on an expiration status of the timer or on reception of a status report from the second wireless communication device.
